(19) United States
(12) Patent Application Publication
(10) Pub. No.: US 2011/0175947 A1
(43) Pub. Date: Jul. 21, 2011

(54) METHOD FOR IMPROVING IMAGE STITCH-IN PHENOMENON

(75) Inventors: Yi-Lan LIN, Taoyuan County (TW); Kuo-Chao YEH, Taoyuan County (TW); Hsiang-Lun LIU, Taoyuan County (TW)

(73) Assignee: Chunghwa Picture Tubes, LTD., Taoyuan (TW)

(21) Appl. No.: 13/074,764

(22) Filed: Mar. 29, 2011

Related U.S. Application Data
(62) Division of application No. 11/459,127, filed on Jul. 21, 2006.

(51) Int. Cl. G09G 5/10

(52) U.S. Cl. 345/690

(57) ABSTRACT

A method for improving image stitch-in phenomenon is disclosed. The method includes the following steps. First, at least a first gray-scale line is inserted into the position of a corresponding number of scan line(s) in a frame. Then, at least a second gray-scale line is inserted into the position of a corresponding number of scan line(s) in the next frame. By inserting gray-scale line(s) into different positions sequentially, the image stitch-in phenomenon will not appear when changing a picture that has been displayed for a long time. The present invention can also improve the stitch-in phenomenon happening in an electronic photo frame and a liquid crystal display as well. Thus, the present invention is able to match the demand of human vision and improves the quality of visual display.

### CROSS-REFERENCE TO RELATED APPLICATION

This is a divisional application of and claims the priority benefit of a prior application Ser. No. 11/459,127, filed on Jul. 21, 2006, now pending. The entirety of the above-mentioned patent applications is hereby incorporated by reference herein and made a part of this specification.

### BACKGROUND OF THE INVENTION

1. Field of the Invention

The present invention relates to a method for improving image stitch-in phenomenon. More particularly, the present invention relates to a method for improving image stitch-in phenomenon through the sequential insertion of gray-scale lines.

2. Description of the Related Art

FIG. 1 is a perspective view showing the internal structure of a conventional liquid crystal display device. As shown in FIG. 1, the conventional liquid crystal display device 100 comprises a polarizing plate 101, a glass substrate 102, an indium-tin-oxide (ITO) film 103, an orientation film 104, a color-filtering plate 105, a thin film transistor (TFT) 106 and a layer of liquid crystal molecules 11. The thin film transistor (TFT) 106 and the indium-tin-oxide (ITO) film 103 apply a voltage to the liquid crystal molecule layer 11 and the orientation film 104 fix the liquid crystal molecules 11 in a particular direction. The color-filtering plate 105 filters a light beam 12 to produce the three primary colors, which is red, green and blue. The polarizing plate 101 permits the entrance and exit of light oriented in a particular direction only. The light beam 12 may come from a back light source (not shown).

The principle behind the operation of the liquid crystal display device 100 is in the capacity of the liquid crystal molecules to spin the incident light. When a voltage is applied to the liquid crystal molecules 11, the liquid crystal molecules will rotate a particular angle. Hence, an incident light beam 12 passing through the linear polarizing surface of the liquid crystal molecules 11 will also be rotated. According to the rotation angle of the polarizing surface, the amount of light 12 passing through the polarizing plate 101 will be different so that different brightness levels appear. After applying a desired voltage to the liquid crystal molecules 11, the liquid crystal molecules 11 will slowly rotate to their corresponding angles so that only a portion of the light 12 will pass through. Consequently, a corresponding gray scale is produced.

When a picture has been displayed on a liquid crystal display device 100 for quite some time, some of the charged ions in the liquid crystal molecules 11 will be attracted to the two ends of the upper and lower glass substrate 102. Therefore, a built-in electric field is established so that a derived capacitor is produced. When a new picture needs to be display on the liquid crystal device 100, the charged ions in the derived capacitor area can hardly be instantaneously released from the derived capacitor. As a result, the liquid crystal molecules 11 are incapable of rotating to their respective angles fast enough so that the so-called image stitch-in phenomenon will occur. When an electronic photo frame has been displayed for a long time or the same picture has been used for a long time before changing to a new picture, the charged ions inside the derived capacitor do not have time to release so that the stitch-in phenomenon is quite prominent. FIG. 2 is a diagram showing a chess-board pattern on the electronic photo frame. If the picture in FIG. 2 has been displayed for a long time but is suddenly changed to show a black picture, a light gray scale pattern will appear like the one shown in FIG. 3. As shown in FIGS. 2 and 3, the dark test blocks 201 in FIG. 2 are changed to light gray scale stitch-in blocks 301 (the light gray scale block 301 in FIG. 3 as spot-filled blocks) in FIG. 3. The stitch-in phenomenon is quite unnatural to human vision so that a better method is needed to remove the stitch-in image.

### SUMMARY OF THE INVENTION

Accordingly, at least one objective of the present invention is to provide a method for improving image stitch-in phenomenon capable of quickly removing the residual image when changing the picture. Furthermore, the picture can be refreshed in a natural and gradual way without changing the whole frame. Moreover, for different display devices or users, parameters can be set to achieve the best result in improving the image stitch-in effect.

To achieve these and other advantages and in accordance with the purpose of the invention, as embodied and broadly described herein, the invention provides a method for improving image stitch-in phenomenon. The method includes the following steps. First, a corresponding number of first gray-scale lines are inserted into the position of at least a scan line in a frame. Then, a corresponding number of second gray-scale lines are inserted into the position of at least a scan line in the next frame. By inserting gray-scale lines into different positions sequentially, the image stitch-in phenomenon will not appear when changing a picture that has been displayed for a long time. The first gray-scale lines and second gray-scale lines, whose number can be adjusted, are sequentially scanned over the whole picture frame. The gray-scale lines are free to have any brightness level (includes black line and white line). Furthermore, the number of gray-scale lines is not limited to one. Moreover, the scanning location of the gray-scale line can be determined arbitrarily.

According to the method for improving image stitch-in phenomenon according to one embodiment of the present invention, further includes inserting a corresponding number of third gray-scale lines to at least a scan line position of the second next frame. The first gray-scale line, the second gray-scale line and the third gray-scale line all have a different gray scale and take turns to scan the frame.

The present invention uses a frame refresh scheme that includes sequentially inserting gray scale line in different positions so that the image stitch-in phenomenon normally occurring in the picture changing process when the same picture is displayed for a long time is improved. Furthermore, for different display devices and users, an optimum improvement in the image stitch-in phenomenon can be achieved by setting a number of parameters. Meanwhile, a natural and gradual refresh to a new frame matches the expectation of human vision.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view showing the internal structure of a conventional liquid crystal display device.

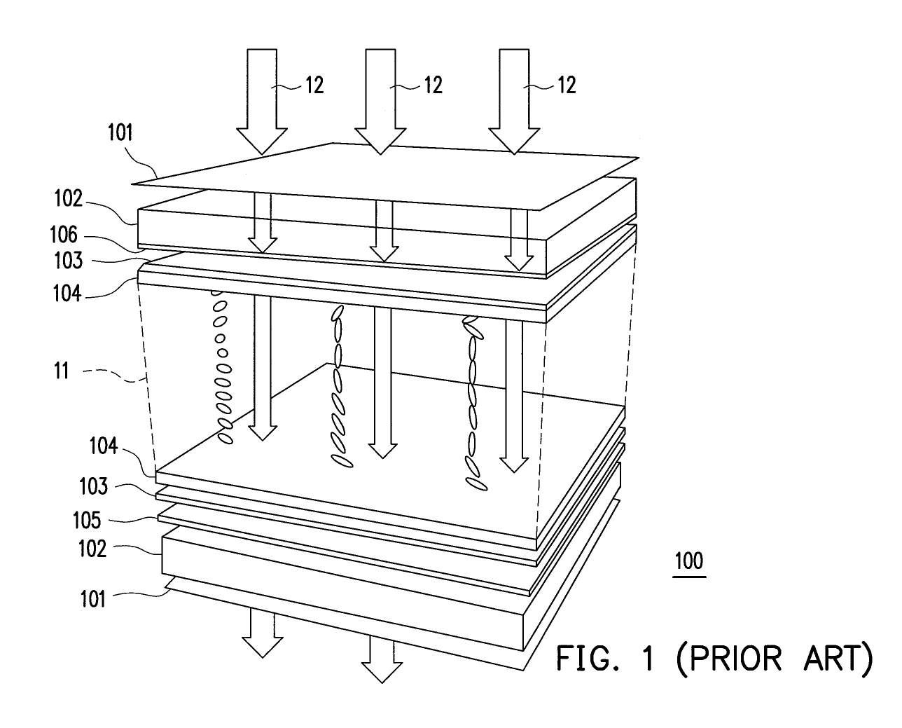

FIG. 2 is a diagram showing a chessboard like electronic frame.

FIG. 3 shows a blank picture in an electronic frame.

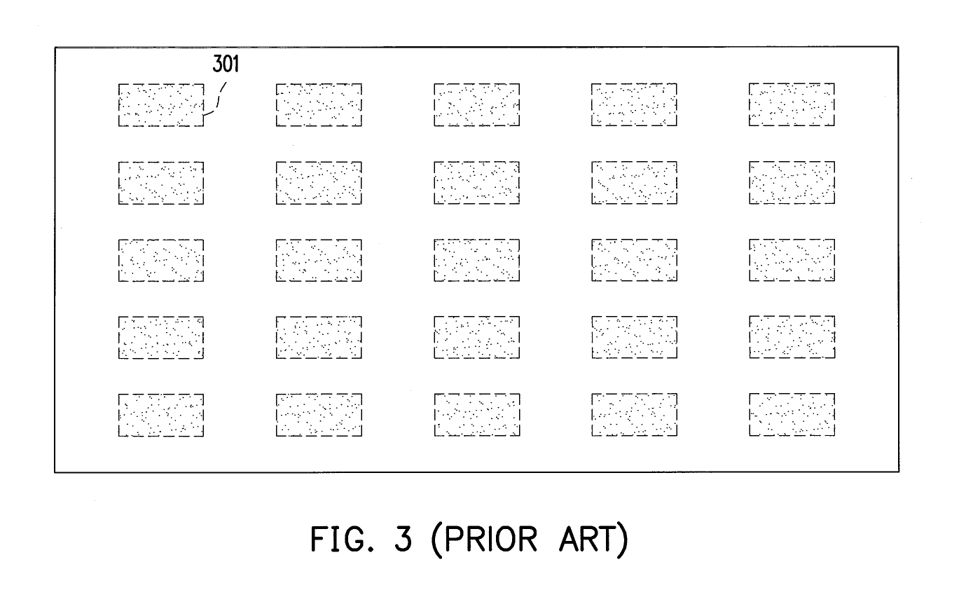

FIG. 4 is a diagram with picture frames showing the sequence of steps for improving the image stitched-in phenomenon according to one embodiment of the present invention.

FIG. 5 is a diagram with picture frames showing the sequence of steps for improving the image stitched-in phenomenon according to another embodiment of the present invention.

FIG. 6 is a diagram with picture frames showing the sequence of steps for improving the image stitched-in phenomenon according to yet another embodiment of the present invention.

FIG. 7 is a diagram with picture frames showing the sequence of steps for improving the image stitched-in phenomenon according to yet another embodiment of the present invention.

FIG. 8 is a diagram with picture frames showing the sequence of steps for improving the image stitched-in phenomenon according to yet another embodiment of the present invention.

FIG. 9 is a diagram with picture frames showing the sequence of steps for improving the image stitched-in phenomenon according to yet another embodiment of the present invention.

FIG. 10 is a flow diagram showing the steps for improving image stitch-in phenomenon according to one embodiment of the present invention.

### DESCRIPTION OF THE PREFERRED EMBODIMENTS

Reference will now be made in detail to the present preferred embodiments of the invention, examples of which are illustrated in the accompanying drawings.

Wherever possible, the same reference numbers are used in the drawings and the description to refer to the same or like parts.

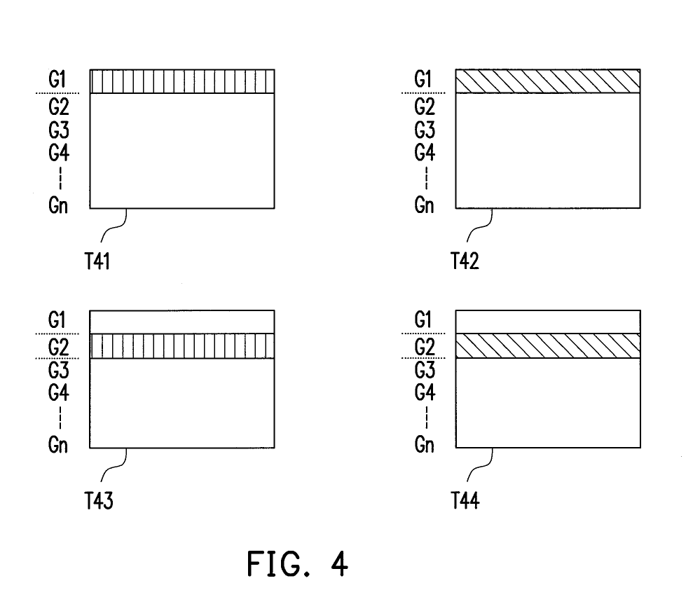

FIG. 4 is a diagram with frames showing the sequence of steps for improving the image stitched-in phenomenon according to one embodiment of the present invention. Each of the frame indicators T41˜T44 in FIG. 4 represents a different frame in a sequence and each of the scan line indicators G1˜Gn represents the position of a different scan line. The method for improving image stitch-in phenomenon includes the following steps. First, a corresponding number of first gray-scale lines are inserted into the position of at least a scan line in a frame. Then, a corresponding number of second gray-scale lines are inserted into the position of at least a scan line in the next frame. In the present embodiment, the first gray-scale line and the second gray-scale line are the black and the middle tone gray line respectively. In other words, a black line and a middle tone gray line are inserted into the frames sequentially. First, a black line (represented using top to bottom parallel straight lines in FIG. 4) is inserted into the scan line position G1 of the frame T41. Thereafter, a middle tone gray line (represented by upper left to lower right slant but parallel straight lines in FIG. 4) is inserted into the scan line position G1 of the next frame T42. Then, a black line is inserted into the scan line position G2 of the second next frame T43. After that, a middle tone gray line is inserted into the scan line position G2 of the frame T44. The above cycle is repeated until the middle tone gray line is inserted into the scan line position Gn.

In the present embodiment, the aforementioned method for improving the image stitch-in phenomenon can be carried out once every preset cycle N (for example, 15 minutes, 30 minutes, 45 minutes and so on). Through the action of inserting different gray-scale line alternately to refresh the entire picture frame, the liquid crystal molecules are actives to remove the image stitch-in phenomenon. Furthermore, the process of carrying out the method of improving the image stitch-in can be limited to within a preset time interval M (for example, 1 minute, 2 minutes, 3 minutes and so on). In this way, the picture is refreshed with scan line(s) at a time instead of the whole frame so that this type of frame refreshing is closer to the demand of human vision.

The method for improving image stitch-in phenomenon in the foregoing embodiment can be summarized using a mathematical rule. The mathematical rule includes, in a multiple of frames, inserting a black line into the i^{th} scan line position of the (2i)^{th} frame and inserting the middle tone gray line into the i^{th} scan line position of the (2i+1)^{th} frame. Here, i is an integer number.

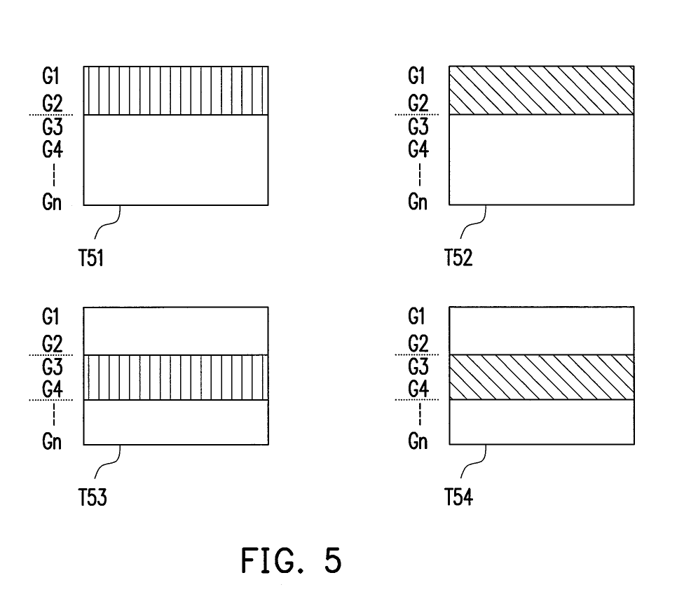

FIG. 5 is a diagram with picture frames showing the sequence of steps for improving the image stitched-in phenomenon according to another embodiment of the present invention. In this embodiment, two black lines and two middle tone gray lines are alternately inserted into the frames. First, in frame T51, two black lines are inserted into the scan line positions G1 and G2. Then, in the next frame T52, two middle tone gray lines are inserted into the scan line positions G1 and G2. Thereafter, in frame T53, two black lines are inserted into the scan line positions G3 and G4. After that, in frame T54, two middle tone gray lines are inserted into the scan line positions G3 and G4. In this way, the aforementioned cycle is repeated until the middle tone gray line is inserted into the scan line position Gn.

The method for improving image stitch-in phenomenon in the foregoing embodiment can be summarized using a mathematical rule. The mathematical rule includes, in a multiple of consecutive frames, inserting the j first gray-scale lines into the (i*j)^{th} to the [(i+1)*j−1]^{th} scan line positions of the (2i)^{th} frame and inserting the j second gray-scale lines into the (i*j)^{th} to the [(i+1)*j−1]^{th} scan line positions of the (2i+1)^{th} frame. Here, i and j are integer numbers. In this embodiment, the first gray-scale line and the second gray-scale line can have different gray scales. Furthermore, the insertion of the gray-scale lines is not limited to the sequence of inserting the black line first and inserting the middle tone gray line thereafter.

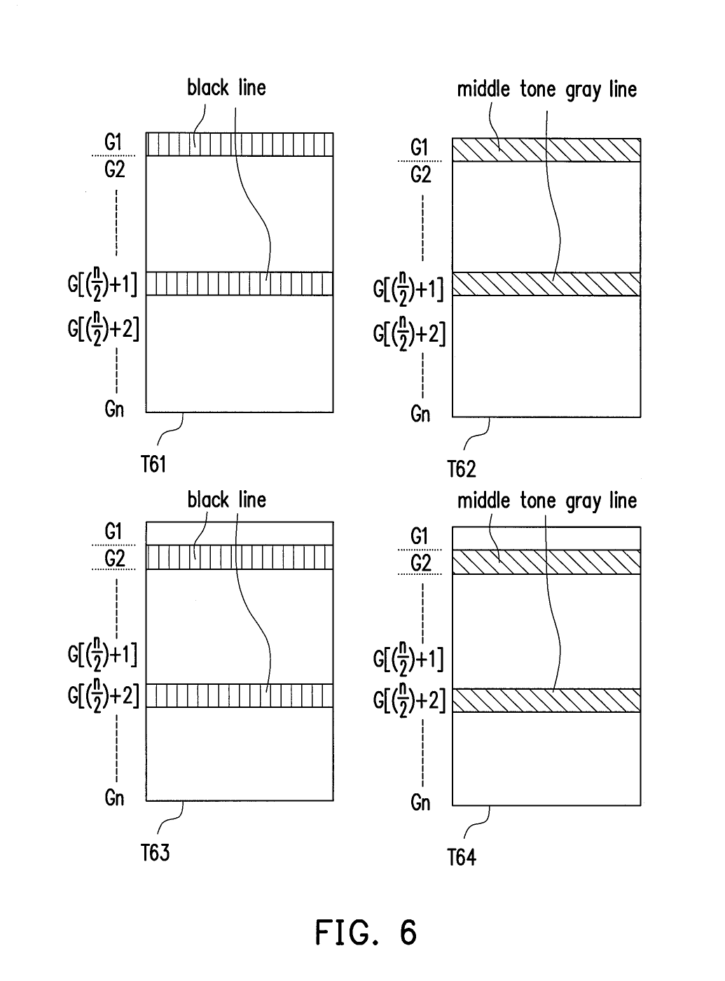

FIG. 6 is a diagram with picture frames showing the sequence of steps for improving the image stitched-in phenomenon according to yet another embodiment of the present invention. In frame T61, two black lines are inserted into the scan line position G1 and the scan line position G[(n/2)+1] respectively. Then, in the next frame T62, two middle tone gray-scale lines are inserted into the scan line position G1 and the scan line position G[(n/2)+1] respectively. Thereafter, in the second next frame T63, two black lines are inserted into the scan line position G2 and the scan line position G[(n/2)+2] respectively. After that, in the frame T64, two middle tone gray-scale lines are inserted into the scan line position G2 and the scan line position G[(n/2)+2] respectively. The aforementioned steps are repeated until the middle tone gray-scale line is inserted into the scan line position Gn. In the present embodiment, the inserted gray-scale lines can be the same black lines, can have an identical gray scale or have a different gray scale. Moreover, the gray-scale lines are not limited to black lines or middle tone gray-scale lines because they can be gray-scale lines of arbitrary brightness levels (includes black line and white line). Furthermore, the number of inserted gray-scale lies is not limited to two. In general, any number of gray-scale lines can be inserted into the frames.

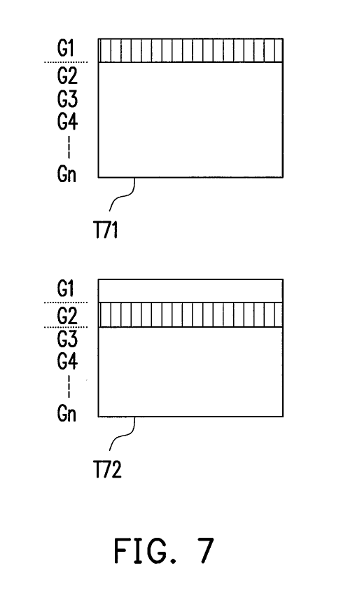

FIG. 7 is a diagram with picture frames showing the sequence of steps for improving the image stitched-in phenomenon according to yet another embodiment of the present invention. In this embodiment, a black line is scanned over the picture to activate the liquid crystal molecules and refresh the picture. First, in frame T71, a black line is inserted into the scan line position G1. Then, in the next frame T72, a black line is inserted into the scan line position G2. The aforementioned steps are repeated until a black line is inserted into the scan line position Gn. Similarly, the present embodiment can be represented using a mathematical rule. In a multiple of consecutive frames, a black line is inserted into the i^{th} scan line position of the i^{th} frame. Here, i is an integer number. Furthermore, the number of black lines inserted into each frame is not limited to one. According to the actual requirements, the designer may insert j gray-scale lines into the (i*j)^{th} to the [i+1)*j−1]^{h} scan line positions of the i^{th} frame in a multiple of consecutive frames. Here, i and j are integer numbers.

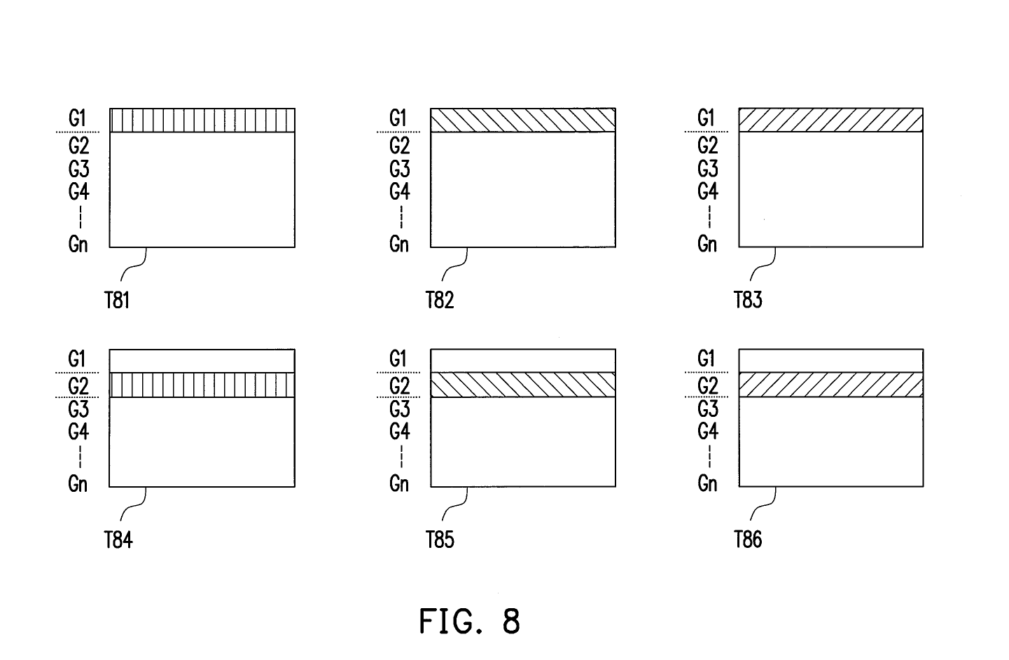

FIG. 8 is a diagram with picture frames showing the sequence of steps for improving the image stitched-in phenomenon according to yet another embodiment of the present invention. The method for improving image stitch-in phenomenon includes the following steps. First, a corresponding number of first gray-scale lines are inserted into at least a scan line position of a frame. Then, a corresponding number of second gray-scale lines are inserted into at least a scan line position of the next frame. Thereafter, a corresponding number of third gray-scale lines are inserted into at least a scan line position of the second next frame. The first gray-scale line, the second gray-scale line and the third gray-scale line all have different gray scales. Here, the first gray-scale lines are assumed to be black lines (represented by a series of top to bottom parallel straight lines in FIG. 8); the second gray-scale lines are assumed to be middle tone gray lines (represented by a series of parallel slant straight lines running from top left to bottom in FIG. 8); and, the third gray-scale lines are assumed to be white lines (represented by a series of parallel slant straight lines running from top right to bottom left in FIG. 8).

First, in frame T81, a black line is inserted into the scan line position G1. Then, in the next frame T82, a middle tone gray line is inserted into the scan line position G1. Thereafter, in the second next frame T83, a white line is inserted into the scan line position G1. In the next frame T84, a black line is inserted into the scan line position G2. Then, in the frame T85, a middle tone gray line is inserted into the scan line position G2. After that, in the frame T86, a white line is inserted into the scan line position G2. The same process is repeated until a white line is inserted into the scan line position Gn. In the present embodiment, three different gray scale lines are alternately inserted into the frames so that three different refreshing conditions are used on all the colors in the frame for activating the liquid crystal molecules. The refreshing method in the present embodiment can be summarized using a mathematical rule. In a multiple of consecutive frames, a black line is inserted into the i^{th} scan line position of the (3i)^{th} frame; a middle tone gray line is inserted into the i^{th} scan line position of the (3i+1)^{th} frame; and, a white line is inserted into the i^{th} scan line position of the (3i+2)^{th} frame. Here, i is an integer number.

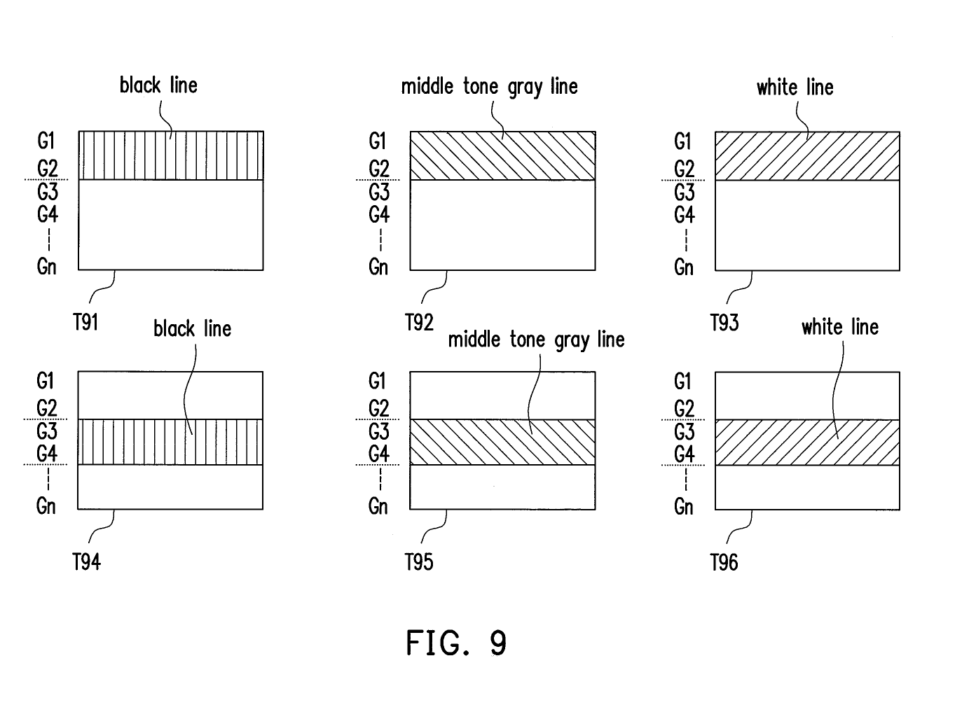

FIG. 9 is a diagram with picture frames showing the sequence of steps for improving the image stitched-in phenomenon according to yet another embodiment of the present invention. In frame T91, two black lines are inserted into the scan line positions G1 and G2 respectively. In the next frame T92, two middle tone gray lines are inserted into the scan line positions G1 and G2 respectively. In the second next frame T93, two white lines are inserted into the scan line positions G1 and G2 respectively. Then, in the frame T94, two black lines are inserted into the scan line positions G3 and G4 respectively. In the next frame T95, two middle tone gray lines are inserted into the scan line positions G3 and G4 respectively. After that, in the frame T96, two white lines are inserted into the scan line positions G3 and G4 respectively. The foregoing steps are repeated until a white line is inserted into the scan line position Gn.

The present embodiment can be summarized using a mathematical rule. In a multiple of consecutive frames, j first gray-scale lines are inserted into the (i*j)^{th} to the [(i+1)*j−1]^{th} scan line positions of the (3i)^{th} frame, j second gray-scale lines are inserted into the (i*j)^{th} to the [(i+1)*j−1]^{th} scan line positions of the (3i+1)^{th} frame, and j third gray-scale lines are inserted into the (i*j)^{th} to the [(i+1)*j−1]^{th} scan line positions of the (3i+2)^{th} frame.

In fact, a refreshing period can be provided. If the refreshing period has not yet expired when the scan line position Gn is reached, another refreshing operation starting from the scan line position G1 will be initiated. In the foregoing embodiment, the refreshing process is not limited to refreshing up to the scan line position Gn.

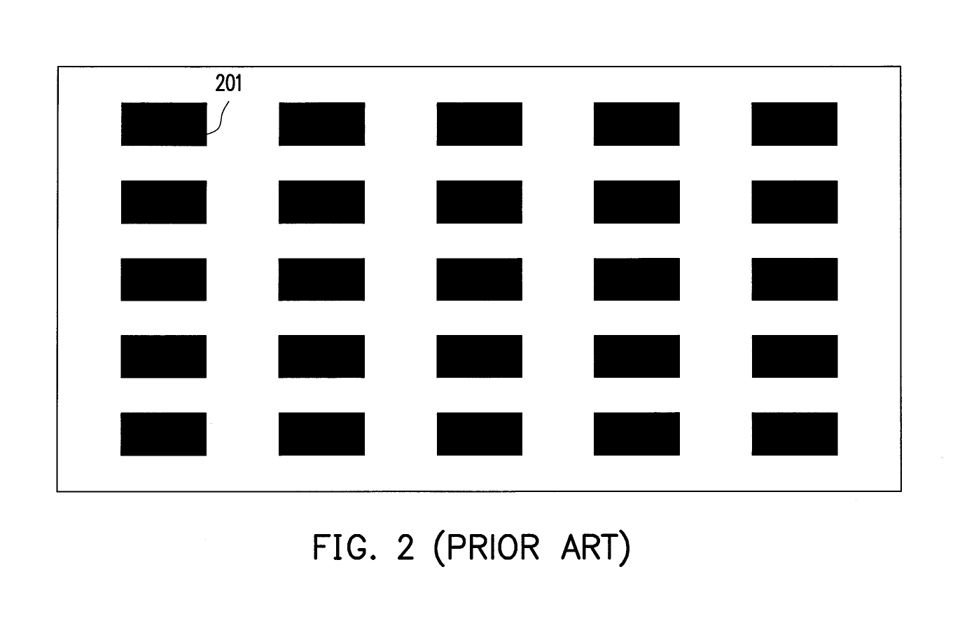

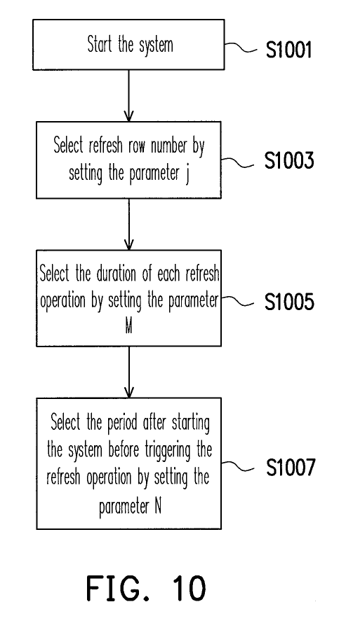

FIG. 10 is a flow diagram showing the steps for improving image stitch-in phenomenon according to one embodiment of the present invention. First, in step S1001, the system for improving image stitch-in phenomenon is turned on. Then, in step S1003, the parameter j is set to select the number of rows to be refreshed each time, for example, one row, two rows or more rows each time. Thereafter, in step S1005, the parameter M is set to select the refreshing period. In step S1007, the parameter N is set to select the waiting period for triggering the refreshing operation after initiating the system. Through the adjustment of the parameter j, M and N, the present invention provides a means of optimizing the operating conditions for dealing with different types of electronic frames, different types of display devices and the need of different users so that the best effect can be obtained. To verify the improvement in the image stitch-in phenomenon, an experiment using the chessboard electronic frame in FIG. 2 as a testing frame is carried out. The result of the experiment is shown in table 1 below. The experiment verifies that no stitch-in images are produced on the frame.

TABLE 1
the result of an experiment on the method for improving the
stitch-in image phenomenon according to the present invention

| | |
|---|---|
| Test pattern | Chessboard grid |
| Test Conditions | 1. Refresh once every 30 minutes. |
| | 2. Insert two lines each time. |
| | 3. Refresh for duration of one minute in |
| | each refreshing operation. |
| Test Duration | 1000 hours |
| Test Result | No stitch-in image |

In summary, the method for improving image stitch-in phenomenon in the present invention includes inserting gray-scale lines into scan line positions so that the stationed liquid crystal molecules can be reactivated. As a result, the appearance of a residual image normally occurring in a picture changing process when the same picture is displayed for a long time is improved. Furthermore, a natural and gradual refresh instead of a whole frame refreshing operation matches the expectation of human vision. Moreover, the refreshing parameters can be adjusted according to the type of electronic frame, the type of display device and the need of the user to produce the best results.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for improving image stitch-in phenomenon, comprising the steps of:
a. inserting two first gray-scale lines respectively into a k^{th} scan line position and an [(n/2)+k]^{th} scan line position of a first frame within consecutive frames, wherein n is the number of the scan line positions, k is an integer number and 1≦k≦n/2, and the first gray-scale line is continuously displayed until the first frame expires;
b. inserting two second gray-scale lines respectively into the k^{th} scan line position and the [(n/2)+k]^{th} scan line position of a second frame next to the first frame within the consecutive frames, wherein the second gray-scale line is continuously displayed until the second frame expires; and
c. carrying on above-mentioned steps a and b repeatedly for the other frames of the consecutive frames until all scan line positions have inserted the first gray-scale line and the second gray-scale line.

2. The method of claim 1, wherein the first gray-scale line and the second gray-scale line have different gray scales.

3. The method of claim 2, wherein the first gray-scale line is a black line and the second gray-scale line is a middle tone gray line.

4. The method of claim 1, wherein the steps for improving image stitch-in phenomenon are performed once after a preset period.

5. The method of claim 1, wherein the total duration of the steps for improving image stitch-in phenomenon lasts no longer than a preset period.

6. The method of claim 1, wherein the steps are used for preventing image stitch-in phenomenon in an electronic photo frame.

7. The method of claim 6, wherein the electronic photo frame has a liquid crystal display panel.
